(19) United States
(12) Patent Application Publication
(10) Pub. No.: US 2026/0200105 A1
(43) Pub. Date: Jul. 16, 2026

(54) ROBOT MANIPULATOR WITH ACTIVE SURFACES

(71) Applicant: SRI INTERNATIONAL, Menlo Park, CA (US)

(72) Inventors: Shenli YUAN, Menlo Park, CA (US); Yilin CAI, Menlo Park, CA (US)

(21) Appl. No.: 19/138,054

(22) PCT Filed: Nov. 7, 2023
(86) PCT No.: PCT/US2023/078976

§ 371 Date: Jun. 11, 2025

Related U.S. Application Data
(60) Provisional application No. 63/431,918, filed on Dec. 12, 2022.

(51) Int. Cl. B25J 15/12; B25J 9/00; B25J 15/02; B25J 15/10

(52) U.S. Cl. CPC B25J 15/12; B25J 9/0015; B25J 15/0233; B25J 15/10

(57) ABSTRACT

A robotic manipulator is provided that exhibits improved grip strength and dexterity. The manipulator includes multiple fingers, each of which includes a grip surface formed by a belt running along a. compliant member. Actuation of the fingers about axes of rotation that are not parallel to the grip surfaces can result in exertion of forces from the compliant member into an object, resulting in deformation of the compliant member, This deformation can improve the contact area and grip strength with which the object is held. The belt can be driven along the grip surface, allowing the object to also be rotated around an axis that is not parallel to the direction along the grip surface while still being held securely. Each finger may also include a compliant joint to allow the fingers to rotate passively when an object is held, orienting the grip surfaces toward the object to improve grip strength.

### CROSS-REFERENCE TO RELATED APPLICATION

This application claims priority to U.S. Provisional Patent Application No. 63/431,918, filed on Dec. 12, 2022, the contents of which are hereby incorporated by reference in their entirety.

### BACKGROUND

Unless otherwise indicated herein, the materials described in this section are not prior art to the claims in this application and are not admitted to be prior art by inclusion in this section.

A variety of applications include the manipulation of objects by robotic hands or other robotic manipulators. Such manipulators can be characterized by the strength and stability with which they can grasp objects and by the dexterity with which they can manipulate those objects (e.g., to rotate an object while maintaining it in the grasp of the manipulator). For many manipulator designs (and, indeed, for the human hand), a more stable, stronger grasp (e.g., by holding an object encircled within multiple fingers, and in contact with the full length of the fingers) often accompanies a reduction in the dexterity with which the object can be manipulated, and vice versa. For example, dexterously grasping the object with the fingertips or a hand or robotic manipulator allows finger walking or other techniques to rotate or otherwise manipulate the object, but also leads to reduced stability of the grasp and increased chance of dropping the object. Additionally, such dexterous manipulation may also implicate increased complexity and cost of the manipulator and increased complexity of controlling the manipulator.

### SUMMARY

In a first aspect, some embodiments of the present disclosure provide a robotic manipulator that includes: (i) a base member, and (ii) three fingers, wherein a given finger of the three fingers includes: (a) a compliant member having a grip surface; (b) a first actuator that is configured to control an angle of the compliant member relative to the base member about a first axis (e.g., about a first axis that is substantially perpendicular to or otherwise not parallel to a manipulator axis of the base member); (c) a belt disposed on the grip surface; and (d) a second actuator that is configured to move the belt relative to the compliant member along the grip surface.

In a second aspect, some embodiments of the present disclosure provide a method that includes: (i) operating a robotic manipulator as in the first aspect to grip an object, wherein operating the robotic manipulator to grip the object includes: operating the first actuator to grip an object with the robotic manipulator such that the belt comes into contact with an object and exerts a force thereon, wherein exerting the force on the object results in the compliant member being deformed and the belt being maintained in contact with the grip surface of the deformed compliant member.

In a third aspect, some embodiments of the present disclosure provide a non-transitory computer-readable storage medium configured to store instructions that, in response to being executed, causes a computing system to perform the method of the second aspect.

In a fourth aspect, some embodiments of the present disclosure provide a system that includes: (i) a controller comprising one or more processors, and (ii) a non-transitory computer-readable storage medium configured to store instructions that, in response to being executed, causes the one or more processors to perform the method of the second aspect.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIG. 1A is a perspective view of an example robotic manipulator that is part of a robotic arm.

FIG. 1B is a side view of elements of the example robotic manipulator depicted in FIG. 1A.

FIG. 1C is an end view of elements of the example robotic manipulator depicted in FIG. 1A.

FIG. 1D is an expanded view of elements of the example robotic manipulator depicted in FIG. 1A.

FIG. 2A is an end view of elements of an example robotic manipulator.

FIG. 2B is an end view of elements of the example robotic manipulator depicted in FIG. 2A.

FIG. 2C is an end view of elements of the example robotic manipulator depicted in FIG. 2A.

FIG. 3 is a perspective view of elements of an example robotic manipulator.

FIG. 4A depicts experimental results.

FIG. 4B depicts experimental results.

FIG. 4C depicts experimental results.

FIG. 5A depicts experimental results.

FIG. 5B depicts experimental results.

FIG. 6 depicts an example robotic manipulator manipulating a variety of objects.

FIG. 6 depicts elements of an example system.

FIG. 7 is a flowchart of an example method.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

### I. Overview

A robotic manipulator may be assessed with respect to its ability to perform a variety of tasks related to the manipulation of objects. This can include both the ability to grasp and move objects from location to location while grasped, and also the ability to manipulate the object (e.g., rotate, deform, operate buttons or other mechanisms of the object) while grasping the object. It is generally desirable to improve both the strength and stability of the robotic manipulator's grasp and the dexterity with which the manipulator can manipulate such a grasped object while also reducing the complexity, size, weight, and cost of the manipulator as well as reducing the complexity of operating the manipulator.

“Robot in-hand manipulation” refers to a robotic system's ability to move (translate and/or rotate) a grasped object with respect to a robotic manipulator (or “hand,” without limitation to human-hand-like manipulators) of the system. In many in-hand manipulation scenarios, the object being manipulated remains grasped in the hand during the hand movement, leading to a trade-off between grasp stability and manipulation dexterity. The goal of in-hand manipulation is to reposition or reorient the grasped object, which by relative motions between the object and the hand. A precision grasp (e.g., using fingertips) is often used for such in-hand manipulations rather than a power grasp for various types of contact (fixed or rolling) between the robot fingers and the object. However, while precision grasp offers better dexterity for manipulation, it generally does not provide a similar level of grasp stability compared to a power grasp. Thus, loss of grasp becomes more likely during such in-hand manipulation using precision grasp.

Precision grasp also generally implicates more complex control schemes and high-dimensional actuation. As an alternative, under-actuated hands can conform to a wide range of objects due to their inclusion of mechanically compliant members. While such compliant manipulators may provide a superior grasp stability without the need for a complex control scheme, their usual reduced degree of controllability can make it to use such manipulators to perform in-hand manipulation.

Robotic manipulators described herein (which may be referred to as “Belt-Augmented Compliant Hands,” or BACH) include compliant members to allow the hand to passively conform to different object shapes and also include active surfaces (e.g., belts) on the grip surfaces of such compliant members to achieve robust and dexterous in-hand manipulation. The use of a compliant member to form the grip surfaces of such a manipulator facilitates strong, stable gripping of objects using simple, low-cost, and easily-controllable elements, such as low degree-of-freedom (DOF) elements. As noted above, under-actuated fingers that incorporate such compliant members can passively conform to various shapes of objects, allowing them to securely grasp different objects without complex control schemes (e.g., as compared to traditional linkage-based under-actuated hands) and using fewer actively controlled DOF (e.g., a single DOF at the base of the compliant finger, as in the manipulators described herein). The inherent compliance of the material of such manipulators makes them suitable for safe and delicate operations, but makes it more difficult for them to perform highly dexterous manipulation. The belts or other active surface disposed along the grip surfaces of the compliant members can compensate for this, allowing the object to be dexterously manipulated while stably grasped by manipulator by actuating the belts to rotate the object within the manipulator.

Since the manipulator is often able to be rotated (e.g., by a joint at the end of a robotic arm to which the manipulator is coupled) about a long axis of the manipulator (or a “manipulator axis”) by an actuator of an arm or other mechanism to which the manipulator is mounted, it is beneficial to configure such a manipulator to facilitate rotation or other manipulations of a grasped object about the two axes perpendicular to the long axis. Accordingly, each finger of the manipulator may be actuated to rotate about a respective axis that is not parallel to (e.g., that is substantially perpendicular to) the manipulator axis, with the belt being configured to be moved along the grip surface of the finger in a direction that is, itself, not parallel to (e.g., substantially perpendicular to) the axis of rotation of the finger. Such a configuration allows the belts to be used to rotate a grasped object in the two rotational DOF perpendicular to the manipulator axis. In combination with an actuator configured to rotate the manipulator as a whole about the manipulator axis (or some other axis approximate thereto), this allows a grasped object to be rotated about all three rotational DOF.

As noted above, the degree of stability of a compliant manipulator in grasping an object can be related to the degree of contact between the manipulator and the object, with the compliance of the manipulator allowing the manipulator to deform to increase the degree of contact therebetween. Such a manipulator could be improved by adding, to each finger of such a manipulator, a hinge or other joint at the base to allow the grip surface of the finger to rotate toward a grasped object, thereby improving grip stability. Such a joint could be actively actuated. Additionally or alternatively, such a joint could be a compliant joint configured to passively orient the corresponding finger toward an object being grasped. Such a passive compliant joint provides benefits with respect to cost, mechanical complexity, control complexity, and power relative to, e.g., an actively actuated joint at the base of each finger.

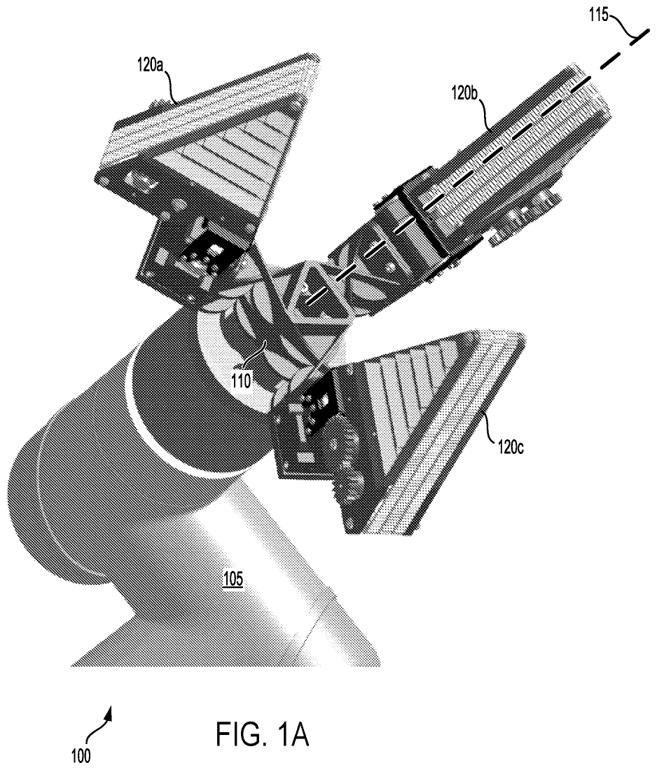

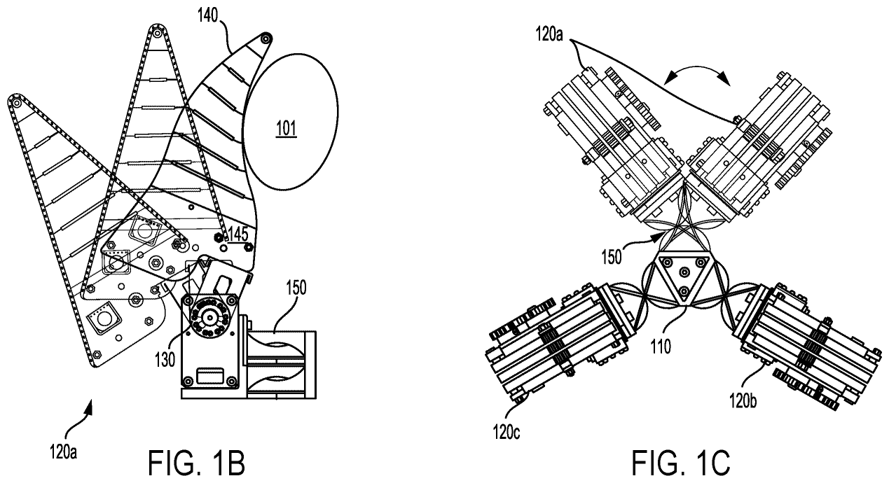

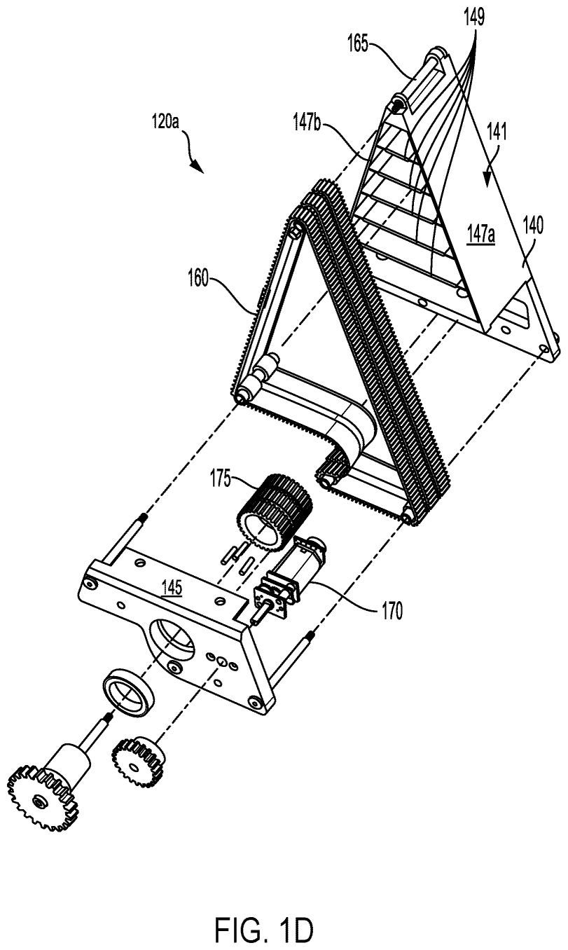

FIG. 1A depicts an example of such a robotic manipulator 100. The manipulator 100 includes a base member 110 to which three fingers 120a, 120b, 120c are coupled. A manipulator axis 115 of the manipulator 100 is defined relative to the base member 110. The manipulator 100 is mounted, via the base member 110, to a robotic arm 105, The arm 105 includes an actuator (not shown) configured to rotate the manipulator 100 about the manipulator axis 115.

FIG. 1B shows the first finger 120a at a variety of different angles or rotation relative to the base member 110 about a first axis of rotation that is not parallel to (e.g., that is substantially perpendicular to) the manipulator axis 115 as a first actuator 130, e.g., a Robotis Dynamixel XM430-W350 actuator, rotates the first finger 120a about the first axis to contact an object 101 and exert forces into the object 101, resulting in deformation of a compliant member 140 of the first finger 120a. FIG. 1D shows an expanded view of elements of the first finger 120a.

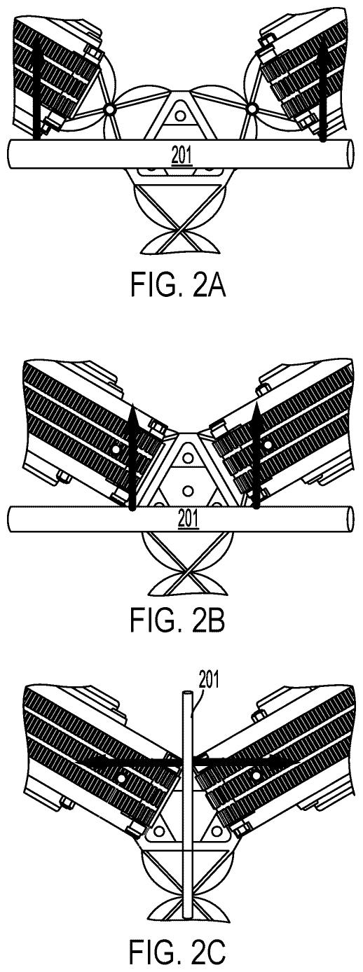

The fingers 120a-c are coupled to the base member 110 via respective optional compliant joints (including first joint 150). The compliant joints are configured to permit the compliant members of their respective fingers to rotate relative to the base member 110 about a second axis that is not parallel to (e.g., that is substantially perpendicular to) the first axis. This is illustrated with respect to the first finger 120a in FIG. 2C. Each joint exerts a force between the base member and the respective compliant member to return the respective compliant member to a rest angle about the respective second axis relative to the base member 110. The compliant joint could be configured in a variety of ways, e.g., as a revolute joint and a spring. For example, the compliant joint could include one or more cross-axis flexural pivots, as the joint 150 of FIGS. 1A-D are.

The compliant member 140 can be coupled to the first actuator 130 of the first finger 120a via a rigid member 140. A belt 160 is disposed on a grip surface 141 of the compliant member 141; a second actuator 170 is configured to move the belt 160 relative to the compliant member 140 along the grip surface 141, e.g., in a direction substantially perpendicular to the first axis about which the first actuator 130 rotates the compliant member 140 relative to the base member 110. As shown, this can include the second actuator 170 exerting forces onto the belt 160 via a timing gear 175 operating on teeth formed into the outer surface of the belt 160; such teeth may also act to improve the grip of the manipulator 100 onto objects. As shown, an axle of the timing gear is coupled to the rigid member 145. Alternatively, the second actuator 170 could act on the belt 160 using a drum or other non-toothed element and/or a timing gear acting on teeth disposed on the inner surface of the belt 160. However, it can be advantageous to leave the inner surface of the belt 160 as a smooth surface (as shown in FIG. 1D) so as to reduce friction between the belt 160 and the grip surface 114, thereby increasing efficiency and/or reducing additional deformation of the compliant member 140 due to motion of the belt 160.

To further increase efficiency and/or reduce belt-related deformation, one or more needle bearings 165 could be disposed at locations of the compliant member 140 where the belt 160 undergoes a large change in angle, e.g., at an end of the compliant member 140 near an end of the grip surface 141.

The compliant member of a robotic manipulator as described herein could be configured in a variety of ways to facilitate exertion of forces onto objects in a deformable manner that increases grip stability and that provides a way for a belt or other element disposed along a grip surface of the compliant member to be used to rotate or otherwise manipulate a gripped object by moving the belt along the grip surface. For example, the example compliant member 140 includes a first compliant plate 147a (which forms the grip surface 141), a second compliant plate 147b, and a plurality of compliant fins 149 that are each coupled between the first compliant plate 147a and the second compliant plate 147b. Such a configuration may be referred to as a “Fin-Ray” mechanism. A compliant member 140 configured in this manner only bends in the presence of an external force. This means that, despite the concavity in the compliant member creating during curling (as a result of exerting forces onto a grasped object), the grasped object will force the belt on to the finger, filling the concavity and preventing the belt from detaching.

Such a compliant member 140 may be configured in a variety of ways. For example, each of the compliant fins 149 narrows as it attaches to one or the other of the compliant plates 147a, 147b, forming a sort of integral joint. This focuses the stress and deformation of the compliant fins 149 in these narrow regions, causing the compliant fins 149 to act, in many circumstances, similarly to rigid plates coupled to the compliant plates 147a, 147b via discrete joints. The composition, number of fins, geometry of the fins and compliant plates, and/or other parameters of such a compliant member 140 can be selected according to an application. For example, the compliant member 140 could be at least partially composed of carbon-filled nylon (e.g., deposited via an additive manufacturing process and/or by injection molding or some other forming process). The compliant member 140 becomes more compliant as the number of fins 149 is reduced and/or the thickness of the compliant plates 147a, 147b is reduced. The compliant member 140 depicted in the Figures includes 5 fins and compliant plates of 0.8 mm thickness in order to balance the compliance and strength of the robotic manipulator 100.

As noted above, a manipulator as described herein can include a joint at the base of each finger configured to facilitate each finger turning ‘toward’ a grasped object, in order to improve grasp stability by increasing the amount of contact between each finger and the object. Such a joint could be actively controlled (e.g., by an actuator) or could be a passive compliant mechanism configured to return the finger to a default angle when no object is being grasped. Such a joint could include a revolute joint and a compliant element coupled thereto (e.g., a spring).

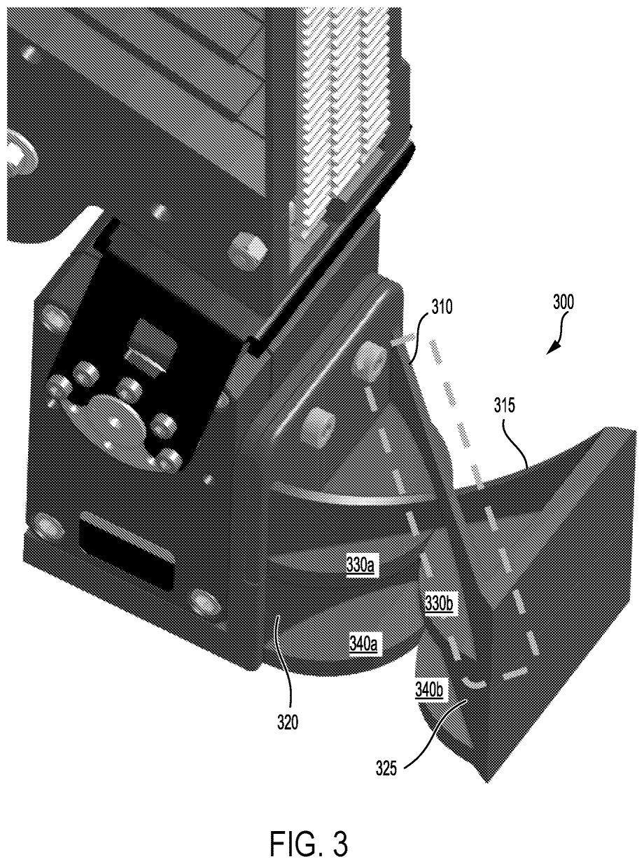

In some examples, the joint could include one or more cross-axis flexural pivots. FIG. 3 depicts such a joint 300. The joint 300 includes a first cross-axis flexural pivot, which is composed of first 310 and second 315 flexible cross-bars that cross the joint 300, and a second cross-axis flexural pivot, which is composed of third 320 and fourth 325 flexible cross-bars that cross the joint 300. Each of the flexible cross-bars has an arcuate edge that faces the opposite flexible cross-bar of a particular cross-axis flexural pivot, allowing the flexible cross-bars of each cross-axis flexural pivot to pass over/under each other as they cross from one side of the joint 300 to the other. A joint of a manipulator as describe herein could include only one cross-axis flexural pivot. However, including two such cross-axis flexural pivots allows each of the cross-axis flexural pivots to have opposite cross-bar arrangements (as depicted in FIG. 3) to at least partially cancel each other's twisting tendencies when the joint is pivoted. Additionally or alternatively, such a joint could include a number of pairs of contact-aided members to counter some of the twisting forces resulting from pivoting of the joint. For example, the joint 300 of FIG. 3 includes a first pair of contact-aided members 330a, 330b and a second pair of contact-aided members 340a, 340b to counter twisting forces caused by the cross-axis flexural pivots, thereby making the motion of the joint more limited to rotation about/translation perpendicular to the axis of rotation of the joint 300.

To ensure that such a joint results in rotation of a finger toward a grasped object, increasing the stability of the grasp, the location of contact between the finger and the object can be controlled relative to the axis of rotation, “center of pivot” (COP) of the joint Indicated in FIGS. 2A-C by the dots). The location of COP allows the corresponding finger to pivot to the desired direction (enhancing contact with a grasped object) regardless of grasping situation. FIG. 2A shows a situation where the locations of contact between a grasped object 201 and two fingers of a robotic manipulator (location of contact and direction of force exerted onto the manipulator from the object 201 indicated by the arrows) result in the joints rotating the fingers toward the object 201, enhancing contact with the object 201 by rotating the grip surfaces of the fingers toward the object 201. (Contact between the object 201 and the third finger is not shown in FIGS. 2A and 2B for clarity of illustration). This is due to the location of contact between the object 201 and each of the fingers being, in a plane perpendicular to the manipulator axis of the manipulator, farther from the manipulator axis than the respective COP of the respective joint. Accordingly, the belt exerting force on the object 210 results in the given finger rotating about the COP to increase an area of contact between the belt and the object 201.

FIG. 2B illustrates an example where the manipulator has not been controlled in this manner; thus, the fingers exerting forces onto the object 201 will result in the joints rotating the grip surfaces of the fingers away from the object, decreasing contact with the object 201 and potentially reducing the stability of grasp of the object 201. FIG. 2C shows how this contact-enhancing effect of the joints can be obtained even for two-finger operation (e.g., two fingers of a three-or more-fingered manipulator or a two-fingered manipulator). So long as the fingers in contact with the object 201 are controlled such that they contact the object 201 at locations that are, in the plane perpendicular to the manipulator axis of the manipulator, farther from the manipulator axis than the respective COPs of their respective joints, the forces exerted between the object 201 and the fingers will rotate the joints such that the grip surfaces of the fingers are brought into increased contact with the object 201.

A robotic manipulator could be configured such that this relationship between the location of contact with between a manipulator finger and a gripped object and the COP of a joint at the base of the finger is always satisfied (e.g., by constructing the manipulator such that the finger cannot reach closer to the manipulator axis than the COP of the joint). Additionally or alternatively, the robotic manipulator could be controlled to maintain this relationship. This could include a controller acting the control the manipulator determining the location of contact between a particular finger of the manipulator and a grasped object and controlling that finger and/or other fingers of the manipulator to maintain the location of contact farther from the manipulator axis than the COP of the corresponding joint. This contact location and determination could be performed on an ongoing basis. For example, as belts on the fingers are operated to rotate an object under grasp, updated locations of contact on the fingers could be determined and used to control the angles of the fingers and/or the motion of the belts thereof to maintain the locations of contact between the object and each of the fingers farther from the manipulator axis than the respective COPs of the respective joints.

A controller of a robotic manipulator as described herein could determine the location of contact between a belt of a finger of the manipulator and a grasped object in a variety of different ways. In some examples, the finger could include force, deformation, pressure, or other types of sensors (e.g., disposed on a grip surface of a compliant member thereof) and the controller could determine the location of contact based on the outputs of such sensors. Additionally or alternatively, sensors in the base of the manipulator (cameras, ultrasonic distance sensors, encoders to measure the angle of actuator(s) and/or joint(s) of the finger(s)) or other locations (e.g., cameras or 3D scanners in a work cell, cameras or 3D scanners on a robotic arm to which the manipulator is mounted) could provide information about the location of an object relative to the manipulator and thus about the location of contact between a belt of a finger of the manipulator and the object. In some examples, a model of the manipulator could be used, alone or in combination with some or all of the sensor data described above, to predict the location of contact based in part on outputs provided to control the manipulator (e.g., an angle of a finger relative to the base member of the manipulator, an angle or translation of a belt along a grip surface of the finger).

### II. Experimental Data

Simulations and other experiments were performed to validate the embodiments described herein.

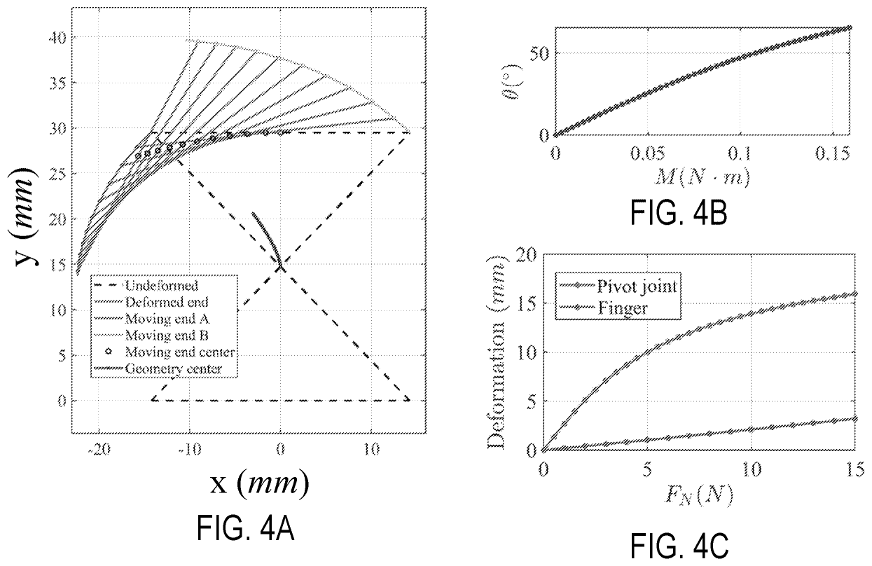

A compliant joint having two cross-axis flexural pivots with opposite cross-bar arrangements and two pairs of contact-aided members as illustrated in FIG. 3 was modeled. The results of this modeling, with varying levels of deflecting moment between 0 and 0.16 N-m applied thereto, are shown in FIGS. 4A-C. FIG. 4A depicts the geometry of the joint at the various levels of moment. FIG. 4B depict the angle of deflection of the joint as a function of applied moment. FIG. 4C depicts the deformation of the joint and of the underlying finger as a function of applied moment.

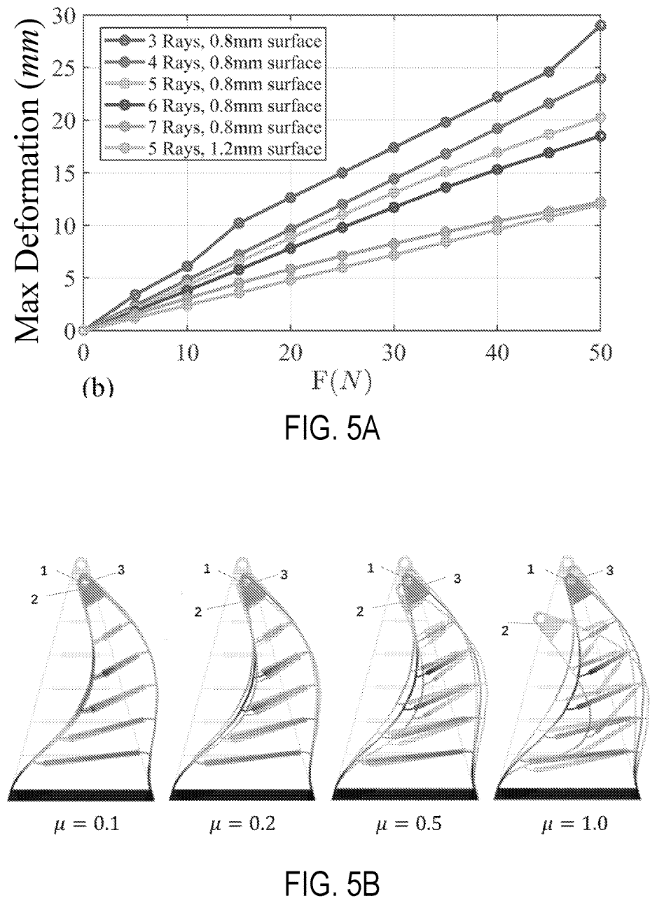

FIGS. 5A and 5B show the results of finite element modeling of a compliant member similar to that depicted in FIGS. 1A-D (a “Fin-Ray” type member). FIG. 5A shows the degree of deformation of the compliant member as a function of applied force for a variety of different numbers of fins and thicknesses of the compliant plates. FIG. 5B shows the pattern of deformation of the compliant member when a deforming force is applied into the compliant member and a normal force is applied along the grip surface of the compliant member, related to friction between the compliant member and a belt moving over the grip surface. Varying levels of friction between the belt and the grip surface (μ) were simulated. The deformation patterns labeled “1” indicate no friction force, “2” indicate friction force in a downward direction (corresponding to the belt being moved toward the base of the finger), and “3” indicate friction force in an upward direction (corresponding to the belt being moved away from the base of the finger). Based on these analyses, the 5-fin member with 0.8 mm thick compliant plates was selected as a balance between compliance and strength. However, other configurations may be chosen depending on the specifics of an application.

Based on these analyses and practical implementation of the manipulators described herein, a coefficient of friction between belt and object of μo=0.5 will result in a manipulator capable of grasping an object having a weight of at least 60 N. For a coefficient of friction between the belt and the grip surface of μi=0.2, a manipulator as described herein will be capable of rotating a grasped object having a weight of at least 118 N.

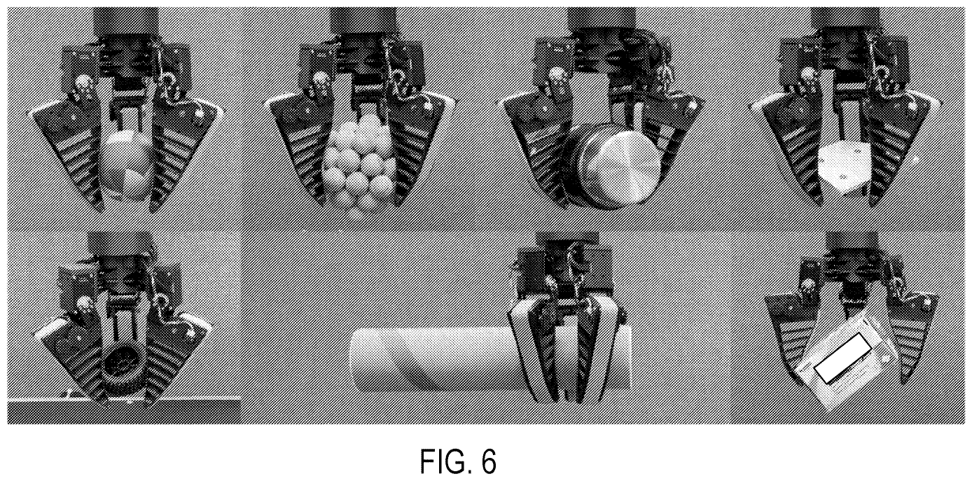

A manipulator as described herein is capable of grasping and manipulating a variety of objects of different sizes, weights, and geometries. This performance is obtained using relatively simple mechanisms with relatively few actively actuated degrees of freedom (e.g., one degree of freedom to control the angle of each finger, and another degree of freedom to control the motion of a belt along the grip surface of each finger). FIG. 6 shows images of such a robotic manipulator being operated to grip and manipulate a variety of objects, including (left to right and top to bottom) a spherical puzzle, an irregularly shaped puzzle, an insulated bottle, an irregular pentagon shaped bracket, an RC car wheel, a long cylinder, and a box (manipulated by two fingers).

### III. Example Systems

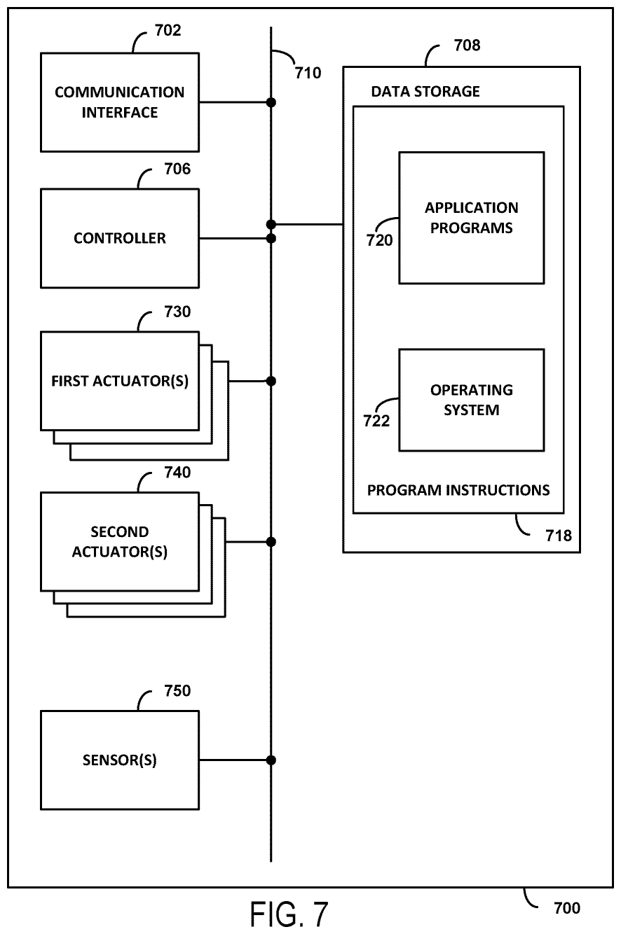

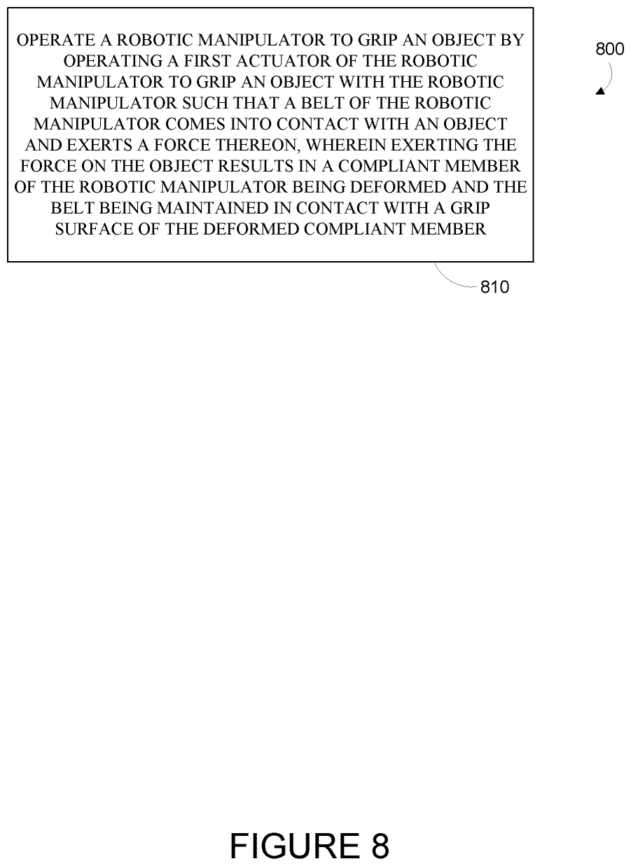

FIG. 7 illustrates an example system 700 (e.g., a robotic arm) that may be used to implement the methods described herein. By way of example and without limitation, system 700 may be a robotic manipulator arm system (e.g., having standardized mechanical and electrical connection features to facilitate integration into standard industrial electrical and mechanical environments), an autonomous robot, or some other type of device or system.

As shown in FIG. 7, system 700 may include a communication interface 702, a controller 706 that includes of one or more processors, one or more first actuators 730 configured to control respective angles of respective fingers of a robotic manipulator, one or more second actuators 740 configured to control respective belts along respective grip surfaces of respective compliant members of respective fingers of the robotic manipulator, sensor(s) 750 for detecting information about the robotic manipulator (e.g., location(s) of contact between finger(s) and a grasped object), and data storage 708, all of which may be communicatively linked together by a system bus, network, or other connection mechanism 710.

Communication interface 702 may function to allow system 700 to communicate, using analog or digital modulation of electric, magnetic, electromagnetic, optical, or other signals, with other devices, access networks, and/or transport networks. Thus, communication interface 702 may facilitate circuit-switched and/or packet-switched communication, such as plain old telephone service (POTS) communication and/or Internet protocol (IP) or other packetized communication. For instance, communication interface 702 may include a chipset and antenna arranged for wireless communication with a radio access network or an access point. Also, communication interface 702 may take the form of or include a wireline interface, such as an Ethernet, Universal Serial Bus (USB), inter-integrated circuit (I2C), and/or serial peripheral interface (SPI) interconnection. Communication interface 702 may also take the form of or include a wireless interface, such as a Wifi, BLUETOOTH®, or wide-area wireless interface (e.g., WiMAX or 3GPP Long-Term Evolution (LTE)). However, other forms of physical layer interfaces and other types of standard or proprietary communication protocols may be used over communication interface 702. Furthermore, communication interface 702 may comprise multiple physical communication interfaces (e.g., a Wifi interface, a BLUETOOTH® interface, and a wide-area wireless interface).

In some embodiments, communication interface 702 may function to allow system 700 to communicate with other devices, remote servers, access networks, and/or transport networks. For example, the communication interface 702 may function to receive commands to operate a robotic manipulator of the system 700. Such commands could take the form of low-level commands to individual components of the manipulator (e.g., actuate first 730 and/or second 740 actuator(s) a particular manner, detect information using the sensor(s) 750) and/or higher level commands that could be interpreted and implemented by the controller 720 (e.g., grasp an object at a particular location, rotate a grasped object to a specified orientation, move the manipulator to a specified location, release a grasped object). The communication interface 702 may function to transmit information to other systems (e.g., to transmit confirmation that a command was received and/or accomplished, to transmit information about the state of a robotic arm and/or outputs of the sensor(s) 750). The communication interface 702 could be used to receive programming updates.

Controller 706 may include one or more general purpose processors—e.g., microprocessors—and/or one or more special purpose processors—e.g., digital signal processors (DSPs), graphics processing units (GPUs), floating point units (FPUs), network processors, tensor processing units (TPUs), or application-specific integrated circuits (ASICs). Data storage 708 may include one or more volatile and/or non-volatile storage components, such as magnetic, optical, flash, or organic storage, and may be integrated in whole or in part with controller 706. Data storage 708 may include removable and/or non-removable components.

The one or more processors of controller 406 may execute program instructions 718 (e.g., compiled or non-compiled program logic and/or machine code) stored in data storage 708 to carry out the various functions described herein. Therefore, data storage 708 may include a non-transitory computer-readable medium, having stored thereon program instructions that, upon execution by system 700, cause system 700 to carry out any of the methods, processes, or functions disclosed in this specification and/or the accompanying drawings.

By way of example, program instructions 718 may include an operating system 722 (e.g., an operating system kernel, device driver(s), and/or other modules) and one or more application programs 720 (e.g., motor driver functions, operational history data, robotic manipulator control data, robotic manipulator calibration data) installed on system 700.

### IV. Example Methods

FIG. 8 is a flowchart of a method 800. The method 800 includes operating a robotic manipulator to grip an object by operating a first actuator of the robotic manipulator to grip an object with the robotic manipulator such that a belt of the robotic manipulator comes into contact with an object and exerts a force thereon, wherein exerting the force on the object results in a compliant member of the robotic manipulator being deformed and the belt being maintained in contact with a grip surface of the deformed compliant member (810). The robotic manipulator includes: (i) a base member; and three fingers, wherein a given finger of the three fingers includes: (a) the compliant member having the grip surface; (b) the first actuator that is configured to control an angle of the compliant member relative to the base member about a first axis (e.g., about a first axis that is substantially perpendicular to or otherwise not parallel to a manipulator axis of the base member); (c) the belt disposed on the grip surface; and (iv) a second actuator that is configured to move the belt relative to the compliant member along the grip surface. The method 800 could include additional elements or features.

### V. Conclusion

The particular arrangements shown in the Figures should not be viewed as limiting. It should be understood that other embodiments may include more or fewer/less of each element shown in a given Figure. Further, some of the illustrated elements may be combined or omitted. Yet further, an exemplary embodiment may include elements that are not illustrated in the Figures.

Additionally, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

Where an axis of rotation or other vector is described herein as being “substantially perpendicular” to some other vector or axis, this includes the two axes and/or vectors being approximately perpendicular but not necessarily exactly perpendicular, e.g., that the angle between the two axes/vectors is between 55 degrees and 125 degrees, between 75 degrees and 105 degrees, or between 85 and 95 degrees, inclusive. Similarly, where an axis of rotation or other vector is described herein as being “substantially parallel” to some other vector or axis, this includes the axes and/or vectors being approximately parallel but not necessarily exactly parallel, e.g., that the angle between the two axes/vectors is between 0 degrees and 35 degrees, between 0 degrees and 15 degrees, or between 0 and 5 degrees, inclusive.

1. A robotic manipulator comprising:
a base member; and
three fingers, wherein a given finger of the three fingers comprises:
a compliant member having a grip surface;
a first actuator that is configured to control an angle of the compliant member relative to the base member about a first axis;
a belt disposed on the grip surface; and
a second actuator that is configured to move the belt relative to the compliant member along the grip surface.

2. The robotic manipulator of claim 1, wherein the given finger further comprises a compliant joint configured to permit the compliant member to rotate relative to the base member about a second axis that is not parallel to the first axis, wherein the compliant joint exerts a force between the base member and the compliant member to return the compliant member to a rest angle about the second axis relative to the base member.

3. The robotic manipulator of claim 2, wherein the compliant joint comprises a revolute joint and a spring.

4. The robotic manipulator of claim 2, wherein the compliant joint comprises a first cross-axis flexural pivot, a second cross-axis flexural pivot, and at least one pair of contact-aided members, wherein the first cross-axis flexural pivot and the second cross-axis flexural pivot have opposite cross-bar arrangements, and wherein the at least one pair of contact-aided members is configured to counter twisting forces exerted across the compliant joint by the first and second cross-axis flexural pivots.

5. The robotic manipulator of claim 1, wherein the given finger further comprises a third actuator that is configured to control an angle of the compliant member relative to the base member about a second axis that is not parallel to the first axis.

6. The robotic manipulator of claim 1, wherein the given finger further comprises a needle bearing, wherein the belt encircles a portion of the compliant member, wherein the needle bearing is disposed at an end of the compliant member near an end of the grip surface, and wherein the belt is in contact with the needle bearing such that the second actuator moving the belt relative to the compliant member along the grip surface results in the belt causing the needle bearing to rotate.

7. The robotic manipulator of claim 6, wherein the given finger further comprises:
a rigid member to which the compliant member is secured, wherein the first actuator exerts forces on the compliant member via the rigid member to control the angle of the compliant member about the first axis; and
a timing gear, wherein the second actuator exerts forces via the timing gear to move the belt along the grip surface, and wherein an axle of the timing gear is coupled to the rigid member.

8. The robotic manipulator of claim 1, wherein the compliant member comprises:
a first compliant plate that defines the grip surface;
a second compliant plate; and
a plurality of compliant fins that are substantially parallel to each other, wherein each complaint fin of the plurality of compliant fins is coupled between the first complaint plate and the second compliant plate.

9. The robotic manipulator of claim 8, wherein the first compliant plate, second compliant plate, and plurality of compliant fins are at least partially composed of carbon-filled nylon.

10. The robotic manipulator of claim 1, further comprising:
a controller operably coupled to the first and second actuators and configured to perform controller operations comprising:
operating the first actuator to grip an object with the robotic manipulator such that the belt comes into contact with an object and exerts a force thereon, wherein exerting the force on the object results in the compliant member being deformed and the belt being maintained in contact with the grip surface of the deformed compliant member.

11. The robotic manipulator of claim 10, wherein the given finger further comprises a compliant joint configured to permit the compliant member to rotate relative to the base member about a second axis that is not parallel to the first axis, wherein the compliant joint exerts a force between the base member and the compliant member to return the compliant member to a rest angle about the second axis relative to the base member, and wherein the controller operations further comprise:
determining a location of contact between the belt and the object, wherein operating the first actuator to grip the object with the robotic manipulator comprises operating the first actuator to grip the object with the robotic manipulator such that the location of contact is, in a plane perpendicular to a manipulator axis of the base member that is not parallel to the first axis, farther from the manipulator axis than the second axis and further such that the belt exerting force on the object results in the given finger rotating about the second axis to increase an area of contact between the belt and the object.

12. The robotic manipulator of claim 10, wherein the controller operations further include operating the second actuator to cause the object to rotate relative to the base member while being gripped by the robotic manipulator.

13. The robotic manipulator of claim 12, wherein the controller operations further comprise, while operating the second actuator to cause the object to rotate:
determining an updated location of contact between the belt and the object; and
operating the first actuator, based on the determined updated location of contact, to continue gripping the object with the robotic manipulator such that the location of contact between the belt and the object is maintained, in the plane perpendicular to a manipulator axis of the base member that is not parallel to the first axis, farther from the manipulator axis than the second axis.

14. The robotic manipulator of claim 1, further comprising an additional finger that comprises:
an additional compliant member having an additional grip surface;
an additional first actuator that is configured to control an angle of the additional compliant member relative to the base member about an additional first axis;
an additional belt disposed on the additional grip surface; and
an additional second actuator that is configured to move the additional belt relative to the additional compliant member along the additional grip surface.

15. A method comprising:
operating a robotic manipulator to grip an object, wherein the robotic manipulator comprises:
a base member; and
three fingers, wherein a given finger of the three fingers comprises: (i) a compliant member having a grip surface; (ii) a first actuator that is configured to control an angle of the compliant member relative to the base member about a first axis; (iii) a belt disposed on the grip surface; and (iv) a second actuator that is configured to move the belt relative to the compliant member along the grip surface;
and wherein operating the robotic manipulator to grip the object comprises:
operating the first actuator to grip an object with the robotic manipulator such that the belt comes into contact with an object and exerts a force thereon, wherein exerting the force on the object results in the compliant member being deformed and the belt being maintained in contact with the grip surface of the deformed compliant member.

16. (canceled)

17. A non-transitory computer-readable storage medium configured to store instructions that, in response to being executed, causes a computing system to perform controller operations comprising:
operating a robotic manipulator to grip an object, wherein the robotic manipulator comprises:
a base member; and
three fingers, wherein a given finger of the three fingers comprises: (i) a compliant member having a grip surface; (ii) a first actuator that is configured to control an angle of the compliant member relative to the base member about a first axis; (iii) a belt disposed on the grip surface; and (iv) a second actuator that is configured to move the belt relative to the compliant member along the grip surface;
and wherein operating the robotic manipulator to grip the object comprises:
operating the first actuator to grip an object with the robotic manipulator such that the belt comes into contact with an object and exerts a force thereon, wherein exerting the force on the object results in the compliant member being deformed and the belt being maintained in contact with the grip surface of the deformed compliant member.

18. (canceled)

19. The non-transitory computer-readable storage medium of claim 17, wherein the given finger further comprises a compliant joint configured to permit the compliant member to rotate relative to the base member about a second axis that is not parallel to the first axis, wherein the compliant joint exerts a force between the base member and the compliant member to return the compliant member to a rest angle about the second axis relative to the base member, and wherein the controller operations further comprise:
determining a location of contact between the belt and the object, wherein operating the first actuator to grip the object with the robotic manipulator comprises operating the first actuator to grip the object with the robotic manipulator such that the location of contact is, in a plane perpendicular to a manipulator axis of the base member that is not parallel to the first axis, farther from the manipulator axis than the second axis and further such that the belt exerting force on the object results in the given finger rotating about the second axis to increase an area of contact between the belt and the object.

20. The non-transitory computer-readable storage medium of claim 17, wherein the controller operations further include operating the second actuator to cause the object to rotate relative to the base member while being gripped by the robotic manipulator.

21. The non-transitory computer-readable storage medium of claim 20, wherein the controller operations further comprise, while operating the second actuator to cause the object to rotate:
determining an updated location of contact between the belt and the object; and
operating the first actuator, based on the determined updated location of contact, to continue gripping the object with the robotic manipulator such that the location of contact between the belt and the object is maintained, in the plane perpendicular to a manipulator axis of the base member that is not parallel to the first axis, farther from the manipulator axis than the second axis.

22. The method of claim 15, further comprising:
operating the second actuator to cause the object to rotate relative to the base member while being gripped by the robotic manipulator.
